(19) United States
(12) Patent Application Publication
(10) Pub. No.: US 2026/0299709 A1
(43) Pub. Date: Oct. 1, 2026

(54) ELECTRONIC DEVICE, CONTROL METHOD, AND NON-TRANSITORY COMPUTER READABLE MEDIUM

(71) Applicant: CANON KABUSHIKI KAISHA, Tokyo (JP)

(72) Inventors: MASAYA SHIMOSE, Kanagawa (JP); KOJI MITO, Kanagawa (JP)

(21) Appl. No.: 19/571,823

(22) Filed: Mar. 19, 2026

(30) Foreign Application Priority Data
Mar. 27, 2025 (JP) 2025-053249

(51) Int. Cl. G06F 3/033; G06F 3/01

(52) U.S. Cl. CPC G06F 3/033; G06F 3/011

(57) ABSTRACT

An electronic device according to the present disclosure executes a setting process of setting any one of a plurality of operation modes including a first operation mode and a second operation mode in which a number of directions allowed to be input is smaller than a number of directions allowed to be input in the first operation mode, as an operation mode of an operation member, the operation member being configured to receive an input direction based on movement of an operation position of a user operation, executes a restriction process of restricting, in the second operation mode, during direction input, a direction allowed to be input to a direction in which input is being performed, and executes a control process of performing control so that display with which a direction allowed to be input is able to be identified is performed.

### BACKGROUND

### Field of the Technology

The present disclosure relates to an electronic device, and more particularly, to a technology of receiving a user operation of moving an operation position and inputting a direction, such as a joystick operation.

### Description of the Related Art

As an application for a smartphone, a camera control application for controlling a camera connected to the smartphone has been proposed. The camera control application has a function of controlling an imaging direction of the camera in a panning direction or a tilting direction according to a user operation of moving an operation position and inputting a direction, such as a joystick operation, for example. In such a function, it is preferable that likelihood of erroneous control (control unintended by a user) is reduced and the imaging direction can be controlled up to a target direction by a small number of user operations.

Japanese Patent Publication No. 2004-157866 discloses a technique for switching an operation mode (a vertical operation mode, a horizontal operation mode, a four-direction operation mode, or the like) of a pointing device according to a display state of a display screen (a screen supporting a vertical direction, a screen supporting a horizontal direction, a screen supporting four directions, or the like).

In the technique disclosed in Japanese Patent Publication No. 2004-157866, likelihood of erroneous control (control unintended by a user) can be reduced by restricting a direction allowed to be input, but the number of user operations cannot be reduced.

### SUMMARY

The present disclosure provides technology capable of reducing likelihood of erroneous control (control unintended by the user) according to a user operation of inputting a direction by moving an operation position, such as a joystick operation, and reducing the number of user operations.

An electronic device according to the present disclosure includes a processor, and a memory storing a program which, when executed by the processor, causes the electronic device to execute a setting process of setting any one of a plurality of operation modes including a first operation mode and a second operation mode in which a number of directions allowed to be input is smaller than a number of directions allowed to be input in the first operation mode, as an operation mode of an operation member, the operation member being configured to receive an input direction based on movement of an operation position of a user operation, execute a restriction process of restricting, in the second operation mode, during direction input, a direction allowed to be input to a direction in which input is being performed, and execute a control process of performing control so that display with which a direction allowed to be input is able to be identified is performed.

Features of the present disclosure will become apparent from the following description of embodiments with reference to the attached drawings. The following description of embodiments is described by way of example.

### BRIEF DESCRIPTION OF THE DRAWINGS

FIG. 1 is a schematic diagram illustrating a configuration example of a system.

FIG. 2 is a block diagram illustrating a configuration example of a camera.

FIG. 3 is a block diagram illustrating a configuration example of a smartphone.

FIGS. 4A and 4B are schematic diagrams illustrating screen examples of a camera control application.

FIGS. 5A to 5D are schematic diagrams illustrating screen examples of the camera control application.

FIGS. 6A to 6D are schematic diagrams illustrating screen examples of the camera control application.

FIGS. 7A to 7C are schematic diagrams illustrating an example of a change in a view angle due to a change in zoom magnification.

FIG. 8 is a schematic diagram illustrating an example of a direction θ, a displacement amount d, and the like.

FIG. 9A is a flowchart illustrating an operation example of the smartphone.

FIG. 9B is a flowchart illustrating an operation example of the smartphone.

FIGS. 10A to 10C are schematic diagrams illustrating screen examples of the camera control application.

FIGS. 11A to 11D are schematic diagrams illustrating screen examples of the camera control application.

FIG. 12 is a schematic diagram illustrating a screen example of the camera control application.

### DESCRIPTION OF THE EMBODIMENTS

Hereinafter, an embodiment of the present disclosure will be described.

### System Configuration

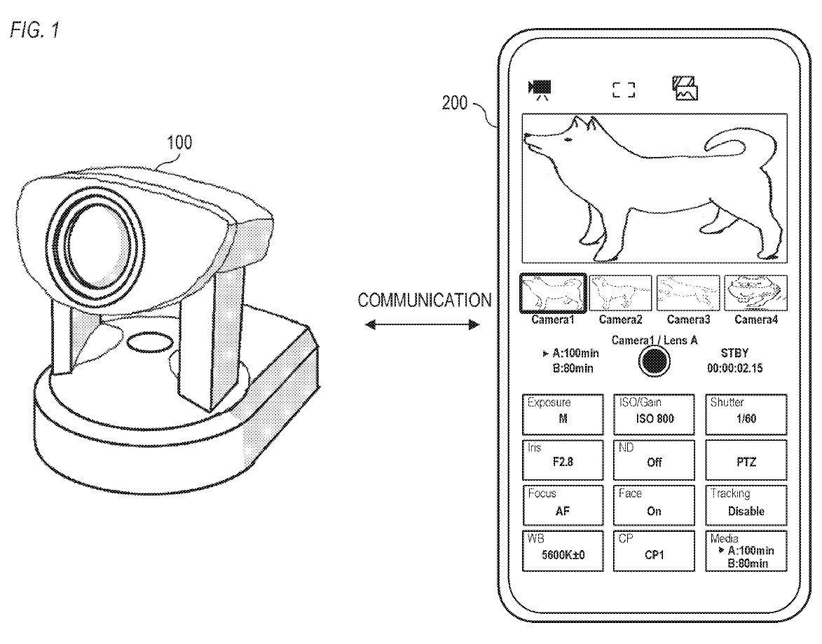

FIG. 1 is a schematic diagram illustrating a configuration example of a system according to the present embodiment. In the system in FIG. 1, a camera 100 and a smartphone 200 are communicably connected to each other. FIG. 1 illustrates one camera 100 but the number of the cameras 100 is not particularly limited, and a plurality of cameras 100 may be connected to the smartphone 200. A communication system (standard) is also not particularly limited and may be, for example, Wi-Fi (registered trademark), Bluetooth (registered trademark), or a wireless communication system exclusive to a manufacturer. The communication between the camera 100 and the smartphone 200 may be wireless communication or wired communication. A communication system in the wired communication is also not particularly limited and may be, for example, RS-232C, RS-422A, USB, or Ethernet (registered trademark). Any communication system capable of transmitting and receiving a video and transmitting and receiving a setting value of a camera is applicable.

### Configuration of Camera

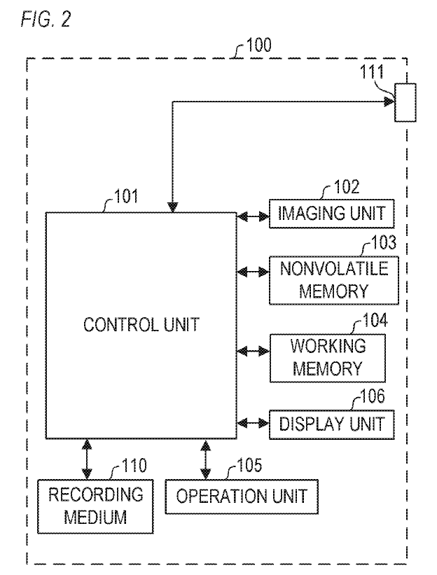

FIG. 2 is a block diagram illustrating a configuration example of the camera 100 (video camera) as an example of a data processing device according to the present embodiment. The data processing device is not limited to the camera 100. For example, the data processing device may be an electronic device such as a tablet device or a personal computer.

A control unit 101 controls each unit in the camera 100 according to an input signal or a program described below. Instead of causing the control unit 101 to control the entire camera 100, processing may be shared by a plurality of pieces of hardware to control the entire camera 100.

An imaging unit 102 converts object light focused by a lens in the imaging unit 102 into an electrical signal, executes noise reduction processing or the like, and outputs image data that is digital data. The captured image data is accumulated in a buffer memory, is subjected to predetermined processing by the control unit 101, and is recorded in a recording medium 110. The imaging unit 102 includes a panning mechanism, a tilting mechanism, and a zooming mechanism, and executes a panning motion, a tilting motion, and a zooming motion (telephoto control operation/wide-angle control operation) according to an instruction (control signal) from the control unit 101.

A nonvolatile memory 103 is a nonvolatile memory that is electrically erasable and recordable, and stores a program described below to be executed by the control unit 101 or the like.

A working memory 104 is used as the buffer memory that temporarily stores the image data captured by the imaging unit 102, an image display memory of a display unit 106, a work area of the control unit 101, or the like.

An operation unit 105 is used for receiving an instruction for the camera 100 from a user. The operation unit 105 includes, for example, operation members operated by the user, such as a power button for instructing ON/OFF of a power supply of the camera 100, a release switch for instructing shooting, or a reproduction button for instructing reproduction of image data. The operation unit 105 also includes a touch panel formed in the display unit 106. The release switch includes a switch SW1 and a switch SW2. The release switch enters a so-called half-pressed state such that the switch SW1 is turned ON. As a result, an instruction for executing shooting preparations operation such as autofocus (AF) processing, autoexposure (AE) processing, auto white balance (AWB) processing, and electronic flash (EF) pre-flash processing is received. The release switch enters a so-called full-pressed state such that the switch SW2 is switched ON. As a result, the instruction for executing shooting is received. The operation unit 105 is not limited to the one described above, and only needs to receive an instruction to the camera 100 from the user. The operation unit 105 is not necessarily provided on the camera 100, and may be provided on an external device.

The display unit 106 displays a live view image (LV image) as a captured image showing an object substantially in real time, a shoot (recorded) captured image, text for interactive operation, and the like. The display unit 106 is not necessarily mounted on the camera 100. The camera 100 can be connected to an internal or external display unit 106, and only needs to have at least a display control function of controlling display of the display unit 106.

The recording medium 110 can store image data output from the imaging unit 102. The recording medium 110 may be attachable and detachable with respect to the camera 100 or may be mounted on the camera 100. The camera 100 only needs to have at least a function of accessing at least the recording medium 110.

A connector 111 is an interface for connection to the external device. The camera 100 can exchange data with the external device via the connector 111. The connector 111 includes, for example, an interface for communication with the external device via a wireless LAN. The control unit 101 implements wireless communication with the external device by controlling the connector 111.

The camera 100 can operate as a slave device in an infrastructure mode of a wireless LAN communication. During operation as the slave device, the camera 100 can be connected to a peripheral access point (hereinafter, AP) to participate in a network formed by the AP. The camera 100 is one type of the AP and can also operate as a simplified AP (hereinafter, simple AP) having a limited function. The AP is an example of a relay device. When the camera 100 operates as the simple AP, the camera 100 itself forms a network. A peripheral device of the camera 100 can recognize the camera 100 as the AP and participate in the network formed by the camera 100. A program for allowing the camera 100 to operate as described above is stored in the nonvolatile memory 103. The camera 100 is one type of the AP, and is a simple AP not having a gateway function of transferring data received from the slave device to an Internet service provider or the like. Accordingly, even when the camera 100 receives data from another device participating in the network formed by the camera 100 itself, the camera 100 cannot transfer the received data to a network such as the Internet. Alternatively, the connector 111 may be an interface of wired communication instead of wireless communication.

As described above, a communication system with the external device is not particularly limited. The connector 111 may be an interface for executing wired communication with a system such as RS-232C, RS-422A, USB, or Ethernet (registered trademark).

### Configuration of Smartphone

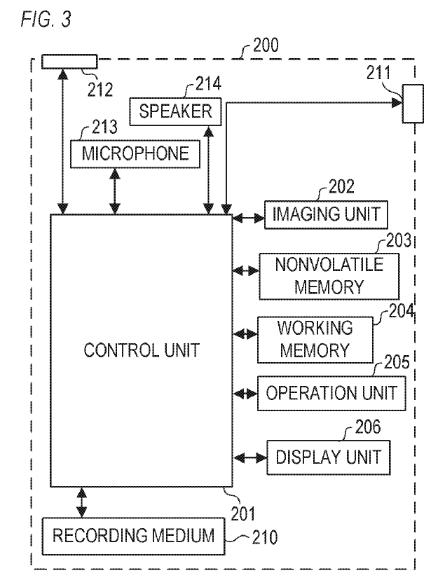

FIG. 3 is a block diagram illustrating a configuration example of the smartphone 200 as an example of a control device according to the present embodiment. The control device is not limited to the smartphone 200. For example, the control device may be an electronic device such as a digital camera, a mobile media player, a tablet device, a personal computer, or a mobile phone.

A control unit 201 controls each unit in the smartphone 200 according to an input signal or a program described below. Instead of causing the control unit 201 to control the entire smartphone 200, processing may be shared by a plurality of pieces of hardware to control the entire smartphone 200.

An imaging unit 202 converts object light focused by a lens in the imaging unit 202 into an electrical signal, executes noise reduction processing or the like, and outputs digital data as image data. The captured image data is accumulated in a buffer memory, is subjected to predetermined processing by the control unit 201, and is recorded in a recording medium 210.

A nonvolatile memory 203 is a nonvolatile memory that is electrically erasable and recordable, and stores an operating system (OS) that is basic software to be executed by the control unit 201, various programs, and the like. A program for communication with the camera 100 is also stored in the nonvolatile memory 203, and is installed as a camera control application. The processing of the smartphone 200 is implemented by reading a program of the camera control application. The camera control application has a function for using basic functions (for example, a function of a wireless LAN, a function of Bluetooth, and a function of calling another application) of the OS installed in the smartphone 200. The camera control application has a remote shooting function of remotely operating and causing the camera 100 to shoot from the smartphone 200 while viewing the LV image obtained from the camera 100 by the smartphone 200. The camera control application has a remote reading function of remotely reading image data stored in a recording medium mounted on the camera 100 or receiving the image data. The OS of the smartphone 200 may have the functions of the present embodiment (for example, the function of the camera control application).

A working memory 204 is used as the buffer memory that temporarily stores the image data captured by the imaging unit 202, an image display memory of a display unit 206, a work area of the control unit 201, or the like.

An operation unit 205 is used for receiving an instruction for the smartphone 200 from the user. The operation unit 205 includes, for example, operation members operated by the user, such as a power button for instructing ON/OFF of a power supply of the smartphone 200 or a touch panel formed in the display unit 206.

The display unit 206 displays an image, text for interactive operation, or the like. The display unit 206 is not necessarily mounted on the smartphone 200. The smartphone 200 can be connected to an internal or external display unit 206, and only needs to have at least a display control function of controlling display of the display unit 206.

The recording medium 210 can store image data output from the imaging unit 202, image data received from the camera 100, or the like. The recording medium 210 may be attachable and detachable with respect to the smartphone 200 or may be mounted on the smartphone 200. The smartphone 200 only needs to have at least a function of accessing at least the recording medium 210.

A connector 211 is an interface for connection to an external device. The smartphone 200 can exchange data with the external device via the connector 211. The connector 211 includes, for example, an interface for communication with the external device via a wireless LAN. The control unit 201 implements wireless communication with the external device by controlling the connector 211.

The smartphone 200 can operate as a slave device in an infrastructure mode of wireless LAN communication and can participate in a network formed by a peripheral AP. The camera 100 may operate as a simple AP such that the smartphone 200 participates in the network formed by the camera 100.

A public network connector 212 is an interface used to perform public wireless communication. The smartphone 200 is connected to another device via the public network connector 212 and can execute data communication with the other device or make a call with a user of the other device. During the call, the control unit 201 acquires a voice signal via a microphone 213 or outputs a voice signal via a speaker 214. The public network connector 212 includes, for example, an interface for executing communication using 3G, 4G, or 5G. The communication system is not particularly limited and may be, for example, LTE, WiMAX, ADSL, or FTTH. The connector 211 and the public network connector 212 do not need to be configured as independent hardware, and for example, one antenna may function as both of the connector 211 and the public network connector 212.

In the following description, the smartphone 200 may be described as the subject of the processing, but in practice, the control unit 201 implements various types of processing by reading and executing the programs stored in the nonvolatile memory 203. Likewise, the camera 100 may be described as the subject of the processing, but in practice, the control unit 101 implements various types of processing by reading and executing the programs stored in the nonvolatile memory 103.

### Screen of Smartphone

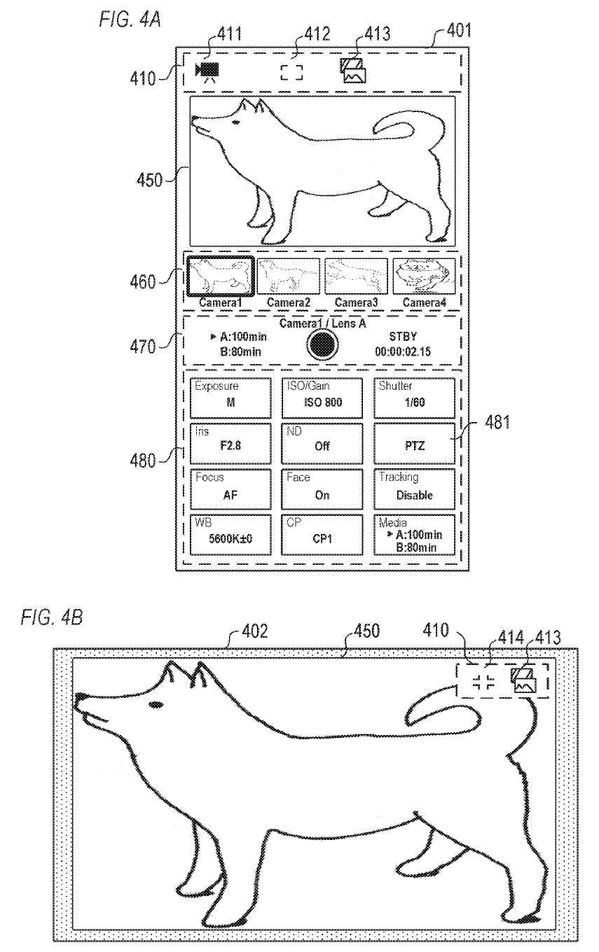

FIGS. 4A to 6D are schematic diagrams illustrating a screen example of the camera control application displayed on the display unit 206 by the smartphone 200. The camera control application is connected to a plurality of cameras simultaneously and can operate each of the cameras. The camera control application receives an LV image or various types of data of the camera via communication with the camera, and displays the LV image or the data on the display unit 206. The display unit 206 is a display unit capable of receiving a touch operation, such as a display unit on which a touch panel is formed.

FIG. 4A illustrates a screen example of a normal display. In FIG. 4A, the control unit 201 is connected to the camera by the camera control application, receives the LV image and various current setting values of the camera from the camera, and displays the LV image and the setting values on a screen 401.

The control unit 201 displays an application setting area 410 for changing various settings in an upper portion of the screen 401. For example, the control unit 201 displays a camera connection setting button 411, a full-screen display button 412, a marker setting button 413, and the like in the application setting area 410.

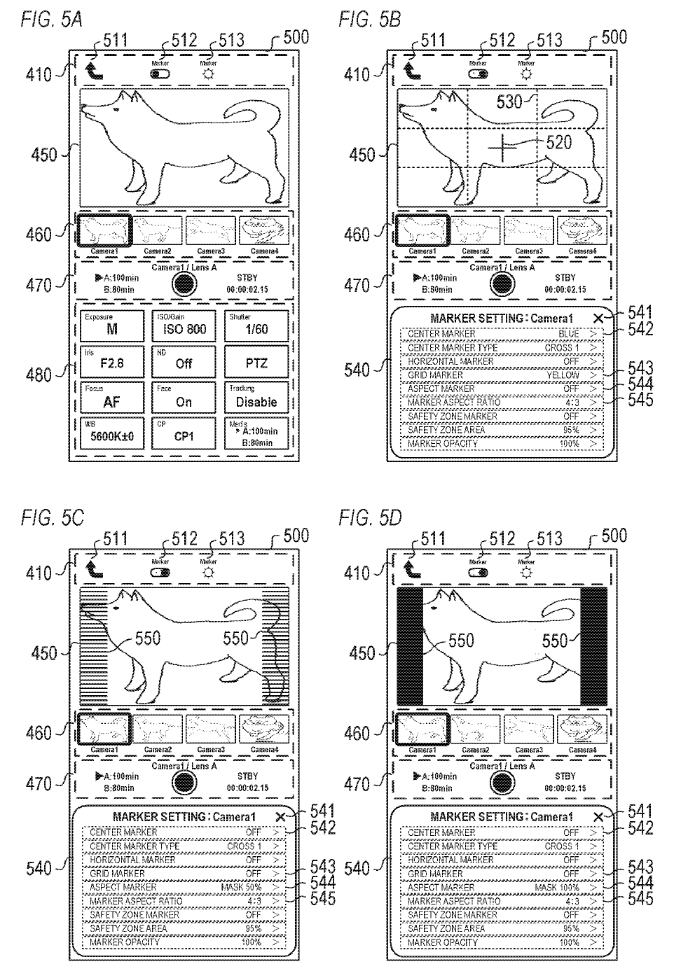

The camera connection setting button 411 is a button for connection or disconnection with the camera, and when the user touches the camera connection setting button 411, the control unit 201 causes a display screen (screen to be displayed) to transition to a setting screen for connection or disconnection with the camera. The full-screen display button 412 is a button for starting full-screen display, and when the user touches the full-screen display button 412, the control unit 201 causes the display screen to transition to a screen 402 in FIG. 4B. The marker setting button 413 is a button for starting a marker setting, and when the user touches the marker setting button 413, the control unit 201 causes the display screen to transition to a screen 500 in FIG. 5A.

The control unit 201 also displays a main LV area 450 and a sub-LV area 460 on the screen 401. The control unit 201 displays in the main LV area 450 an LV image (main image) acquired from the camera to be operated, and displays in the sub-LV area 460 all of LV images acquired from the connected cameras. In FIG. 4A, four cameras (Cameras 1 to 4) are connected, and four LV images acquired from the four cameras are aligned and displayed in the sub-LV area 460. When the user touches an LV image displayed in the sub-LV area 460, the control unit 201 selects the touched LV image as a main image, and selects a camera corresponding to the touched LV image as the camera to be operated. The control unit 201 displays a cursor surrounding the selected LV image. The control unit 201 displays in the main LV area 450 the same LV image as the selected LV image.

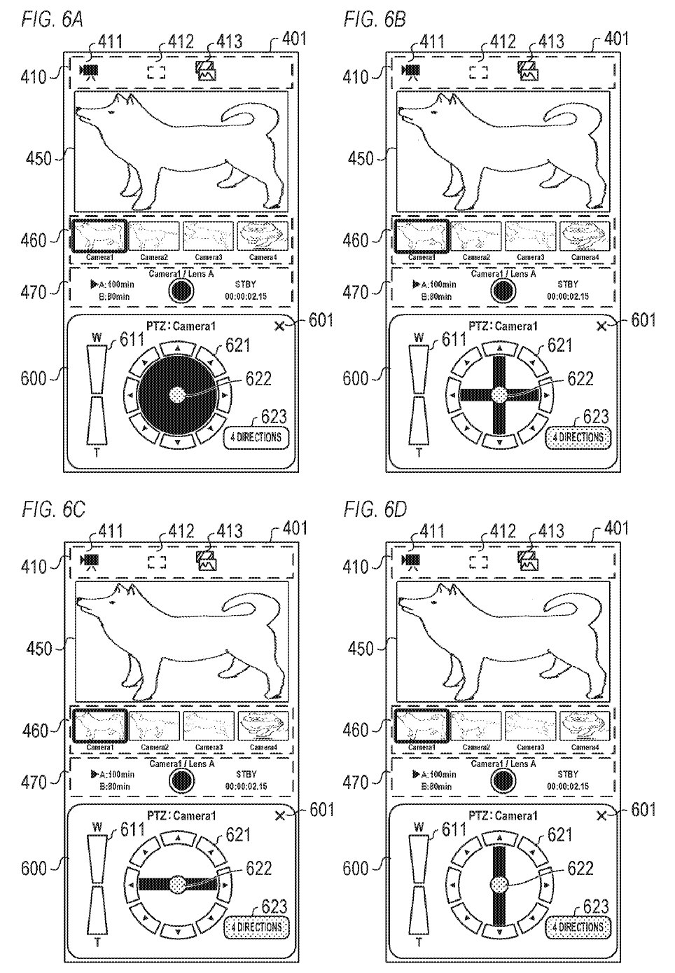

The control unit 201 also displays a recording information area 470 and an operation area 480 on the screen 401. In the recording information area 470, the control unit 201 displays a recording state of an image in the camera to be operated or displays a recording start/stop button for instructing start or stop of recording. For example, as the recording state, a medium remaining time, a time code, a REC (recording)/STBY (standby) state, or the like is displayed. When the user touches the recording start/stop button at the center, the control unit 201 instructs the camera to be operated to start or stop recording an image. The control unit 201 displays an operation button group in the operation area 480. A current setting value to be changed by an operation button is displayed on the operation button. When the user touches the operation button, the control unit 201 instructs the camera to be operated to change the setting value corresponding to the touched operation button or transitions the display screen to a setting screen for changing the setting value corresponding to the touched operation button. When the user executes a sliding operation of touching the operation area 480 and moving the touch position (touch move), the control unit 201 scrolls the operation button group and displays operation buttons that were not displayed in the operation area 480. The operation button group includes, for example, a plurality of buttons related to exposure, shutter speed, zooming, focusing, and the like. In FIG. 4A, a PTZ (panning/tilting/zooming) operation button 481 is a button for enabling a PTZ operation, and when the user touches the PTZ operation button 481, the control unit 201 displays a PTZ operation screen 600 in FIG. 6A.

FIG. 4B illustrates a screen example of full screen display. For example, when the user touches the full-screen display button 412 in FIG. 4A, the control unit 201 transitions the display screen to the screen 402 in FIG. 4B. In FIG. 4B, the main LV area 450 (main image) is displayed on the entire screen. The application setting area 410 is displayed in superposition with the main LV area 450 (main image). In FIG. 4B, the marker setting button 413 and a normal display button 414 are displayed in the application setting area 410. When the user touches the marker setting button 413, the control unit 201 transitions the display screen to the screen 500 in FIG. 5A. When the user touches the normal display button 414, the control unit 201 transitions the display screen to the screen 401 in FIG. 4A.

FIGS. 5A to 5D illustrate screen examples related to display of a marker. When the user touches the marker setting button 413 in FIGS. 4A and 4B, the control unit 201 transitions the display screen to the screen 500 in FIG. 5A. In FIG. 5A, a return button 511, a marker display switching button 512, and a detailed marker setting button 513 are displayed in the application setting area 410.

When the user touches the return button 511, the control unit 201 transitions the display screen to the screen 401 in FIG. 4A.

When the user touches the marker display switching button 512, the control unit 201 switches the display of the marker between enabled (ON) and disabled (OFF). In a case where the display of the marker is disabled, as illustrated in FIG. 5A, the control unit 201 displays the marker display switching button 512 in a state indicating that the display of the marker is disabled, and does not display the marker in the main LV area 450 (main image). In a case where the display of the marker is enabled, as illustrated in FIGS. 5B to 5D, the control unit 201 displays the marker display switching button 512 in a state indicating that the display of the marker is enabled, and displays the marker in the main LV area 450 (main image).

When the user touches the detailed marker setting button 513, the control unit 201 displays a detailed marker setting screen 540 in FIGS. 5B to 5D. The detailed marker setting screen 540 includes a plurality of items such as a close button 541, a center marker setting 542, a grid marker setting 543, an aspect marker setting 544, and a marker aspect ratio setting 545.

When the user touches the close button 541, the control unit 201 hides the detailed marker setting screen 540.

In a case where the display of the marker is enabled, the control unit 201 displays the marker in the main LV area 450 according to setting content of the detailed marker setting screen 540. In the detailed marker setting screen 540 in FIG. 5B, the center marker setting 542 is set to blue, and the grid marker setting 543 is set to yellow. Therefore, in the main LV area 450 in FIG. 5B, a center marker 520 is displayed in blue, and a grid marker 530 is displayed in yellow. In the detailed marker setting screen 540 in FIG. 5C, the aspect marker setting 544 is set to mask 50%, and the marker aspect ratio setting 545 is set to 4 : 3. Therefore, in the main LV area 450 in FIG. 5C, a mask with 50% opacity is displayed as an aspect marker 550 of 4 : 3. In the detailed marker setting screen 540 in FIG. 5D, the aspect marker setting 544 is set to mask 100%, and the marker aspect ratio setting 545 is set to 4 : 3. Therefore, in the main LV area 450 in FIG. 5D, a mask with 100% opacity is displayed as an aspect marker 550 of 4 : 3.

FIGS. 6A to 6D illustrate screen examples related to the PTZ operation. When the user touches the PTZ operation button 481 in FIG. 4A, the control unit 201 displays the PTZ operation screen 600 in FIG. 6A. The PTZ operation screen 600 includes a close button 601, a zoom operation button 611, a direction button 621, a joystick 622, a direction restriction button 623, and the like. Because input of directions with the joystick 622 is allowed, the direction button 621 may not be displayed.

When the user touches the close button 601, the control unit 201 hides the PTZ operation screen 600.

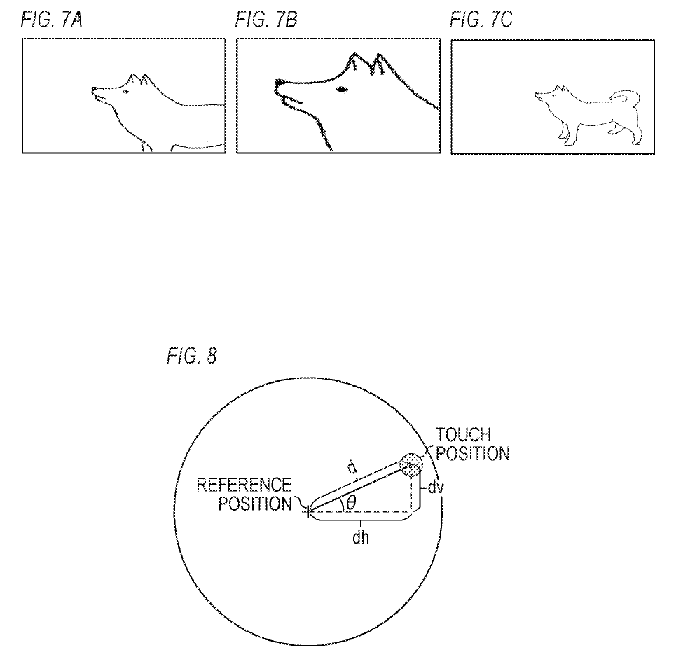

When the user touches the zoom operation button 611, the control unit 201 controls (changes) a zoom magnification of the camera to be operated. For example, the control unit 201 increases the zoom magnification (zoom-in) when an upper side of the zoom operation button 611 is touched, and decreases the zoom magnification (zoom-out) when a lower side of the zoom operation button 611 is touched. The control unit 201 displays in the main LV area 450 and sub-LV area 460 the LV image at a current zoom magnification. In a case where the zoom magnification is changed, the control unit 201 displays in the main LV area 450 and sub-LV area 460 the LV image at a changed zoom magnification. For example, a view angle of the LV image changes from the view angle in FIG. 7A to the view angle in FIG. 7B by zooming in, and the view angle of the LV image changes from the view angle in FIG. 7A to the view angle in FIG. 7C by zooming out. While the zoom operation button 611 is touched, the smartphone 200 repeatedly transmits at predetermined time intervals an amount of change in zoom magnification to the camera to be operated. The amount of change in zoom magnification to be repeatedly transmitted may be a fixed value determined in advance by a manufacturer or the like or may be a value set by the user. The user operation and the display items (operation members) for changing the zoom magnification are not limited to those described above.

When the user touches the direction button 621, the control unit 201 controls (changes) an imaging direction of the camera to be operated, in a panning direction (horizontal direction) or a tilting direction (vertical direction). The control unit 201 tilts the imaging direction upward when the direction button 621 indicating an upward direction is touched, and tilts the imaging direction downward when the direction button 621 indicating a downward direction is touched (tilting motion). The control unit 201 tilts the imaging direction leftward when the direction button 621 indicating a leftward direction is touched, and tilts the imaging direction rightward when the direction button 621 indicating a rightward direction is touched (panning motion). When the direction button 621 indicating an upper right direction is touched, the control unit 201 performs a panning motion of tilting the imaging direction rightward, and performs a tilting motion of tilting the imaging direction upward. When the direction button 621 indicating a lower right direction is touched, the control unit 201 performs a panning motion of tilting the imaging direction rightward, and performs a tilting motion of tilting the imaging direction downward. When the direction button 621 indicating a lower left direction is touched, the control unit 201 performs a panning motion of tilting the imaging direction leftward, and performs a tilting motion of tilting the imaging direction downward. When the direction button 621 indicating an upper left direction is touched, the control unit 201 performs a panning motion of tilting the imaging direction leftward, and performs a tilting motion of tilting the imaging direction upward. While the direction button 621 is touched, the smartphone 200 repeatedly transmits at predetermined time intervals an amount of change in imaging direction (control value of the panning motion (pan control value) and control value of the tilting motion (tilt control value)) to the camera to be operated. The amount of change in imaging direction to be repeatedly transmitted may be a fixed value determined in advance by the manufacturer or the like or may be a value set by the user.

Similarly to the direction button 621, the joystick 622 is an interface (operation member) for inputting a direction. With the joystick 622, by movement of a touch position (operation position), not only a direction but also an amount of displacement of the touch position from a touch position before the movement can be input. The user inputs the direction and the displacement amount from a reference position, which is a predetermined position of the joystick 622 (in the present embodiment, the center position of the joystick 622), with a swipe operation (slide operation) of touching the reference position and moving the touch position.

The control unit 201 sets any one of a plurality of operation modes including an operation mode (unrestricted mode) in FIG. 6A and an operation mode (restricted mode) in FIG. 6B as the operation mode of the joystick 622. In FIG. 6A, 360° directions (parallel to the screen) are allowed to be input, and a black circle is displayed as a background of the joystick 622 such that it is able be identified that 360° directions are allowed to be input. In FIG. 6B, the number of directions allowed to be input is smaller than that in FIG. 6A. In FIG. 6B, the horizontal direction (left-right direction) and the vertical direction (up-down direction) alone are allowed to be input, and a black cross is displayed as the background of the joystick 622 such that it is able to be identified that the horizontal direction and the vertical direction alone are allowed to be input. When the user touches the direction restriction button 623, the control unit 201 switches the operation mode of the joystick 622 between the operation mode (unrestricted mode) in FIG. 6A and the operation mode (restricted mode) in FIG. 6B. In FIGS. 6A and 6B, the direction restriction buttons 623 are displayed in different modes. The plurality of operation modes may include operation modes other than the operation modes in FIGS. 6A and 6B.

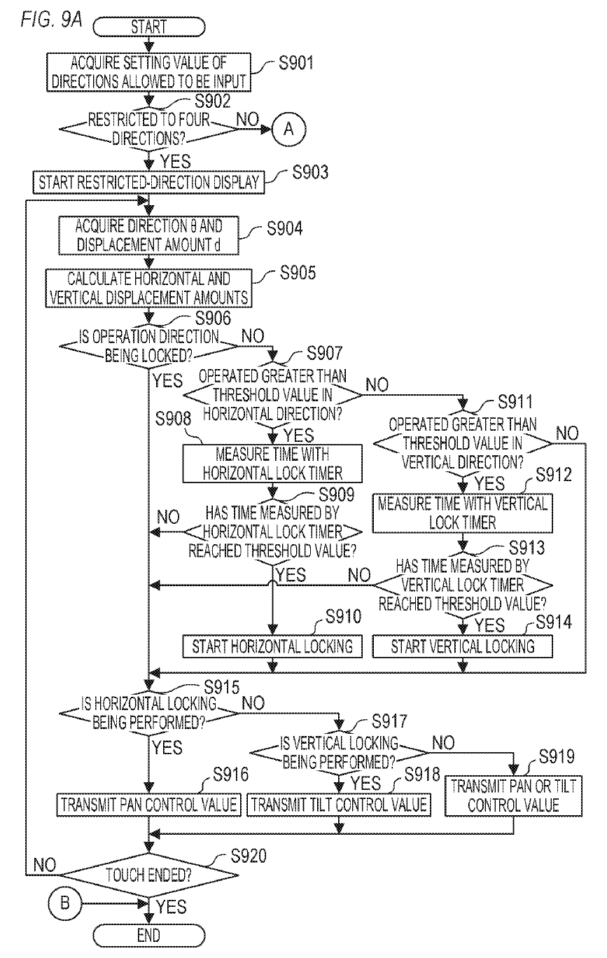

When the user performs a swipe operation on the joystick 622, the control unit 201 determines a horizontal displacement amount dh and a vertical displacement amount dv on the basis of a direction θ that is input, and a displacement amount d as illustrated in FIG. 8. The direction θ is an angle of the joystick 622 with respect to the reference position, and is an angle of 0° or more and less than 360° (0 rad or more and less than 2π rad). The horizontal displacement amount dh is calculated by d x cosθ, and the vertical displacement amount dv is calculated by d x sinθ.

In a case where the horizontal displacement amount dh is a positive value, the control unit 201 tilts the imaging direction rightward at a faster speed as an absolute value of the horizontal displacement amount dh is greater, and in a case where the horizontal displacement amount dh is a negative value, the control unit 201 tilts the imaging direction leftward at a faster speed as the absolute value of the horizontal displacement amount dh is greater (panning motion). In a case where the vertical displacement amount dv is a positive value, the control unit 201 tilts the imaging direction upward at a faster speed as an absolute value of the vertical displacement amount dv is greater, and in a case where the vertical displacement amount dv is a negative value, the control unit 201 tilts the imaging direction downward at a faster speed as the absolute value of the vertical displacement amount dv is greater (tilting motion). While the swipe operation is being performed on the joystick 622, the smartphone 200 repeatedly transmits at predetermined time intervals an amount of change in imaging direction (control value of the panning motion (pan control value) and control value of the tilting motion (tilt control value)) to the camera to be operated. The pan control value to be repeatedly transmitted is a value obtained by multiplying the horizontal displacement amount dh by a predetermined coefficient, and the tilt control value to be repeatedly transmitted is a value obtained by multiplying the vertical displacement amount dv by a predetermined coefficient. The predetermined coefficient may be a fixed value determined in advance by the manufacturer or the like or may be a value set by the user.

In a case where the directions allowed to be input with the joystick 622 are the horizontal direction and the vertical direction alone (in a case of the restricted mode), the direction θ is restricted to 0°, 90°, 180°, and 270° (0 rad, π/2 rad, πrad, and 3π/2 rad). For example, the control unit 201 restricts the direction θ of 0° or more and less than 45° and the direction θ of 315° or more and less than 360° to 0°, and restricts the direction θ of 45° or more and less than 135° to 90°. The control unit 201 restricts the direction θ of 135° or more and less than 225° to 180°, and restricts the direction θ of 225° or more and less than 315° to 270°. For determining the horizontal displacement amount dh and the vertical displacement amount dv, the direction θ before the restriction (displacement direction of the touch position from the reference position (the touch position before the movement)) may be used, or the direction θ after the restriction may be used.

As long as the displacement amount of the touch position from the reference position is determined, the method for determining the horizontal displacement amount dh and the vertical displacement amount dv is not particularly limited. As long as the pan control value and the tilt control value are determined on the basis of a swipe operation on the joystick 622, a method for determining the pan control value and the tilt control value is not particularly limited.

The joystick 622 may be able to input directions alone, or perform the panning motion or the tilting motion at a speed independent of the displacement amount d. The operation member that receives the user operation of moving the operation position and inputting the direction is not limited to the joystick 622. Instead of the swipe operation on the joystick 622, another user operation of touching and moving the touch position may be performed. Instead of the swipe operation on the joystick 622, a swipe operation on the main LV area 450 (a user operation of touching the main LV area 450 and moving the touch position) may be performed. In that case, the main LV area 450 may perform display with which directions allowed to be input are able to be identified. Instead of the swipe operation on the joystick 622 which is a display item, an operation on a joystick which is a physical operation member may be performed.

### Operation of Smartphone

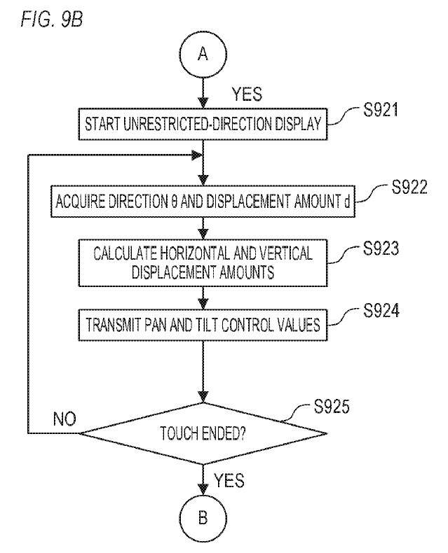

FIGS. 9A and 9B are flowcharts illustrating an operation example of the smartphone 200. The operation in FIGS. 9A and 9B is implemented by the control unit 201 loading a program recorded in the nonvolatile memory 203 (for example, the program of the camera control application) into the working memory 204 and executing the program. For example, when the reference position of the joystick 622 is touched, the operation in FIGS. 9A and 9B starts.

In S901, the control unit 201 acquires a setting value of the directions allowed to be input (the directions allowed to be input with the joystick 622) from the nonvolatile memory 203 and loads the setting value into the working memory 204.

In S902, the control unit 201 determines whether or not the directions allowed to be input are restricted to the horizontal direction and the vertical direction (four directions of up, down, left, and right), on the basis of the setting value acquired in S901. This determination may be interpreted as a determination as to whether or not the operation mode of the joystick 622 is in the restricted mode. The control unit 201 performs control such that, when the directions allowed to be input are restricted to the four directions (in a case of the restricted mode), the process proceeds to S903, and otherwise (in the unrestricted mode), the process proceeds to S921.

In S903, the control unit 201 performs, on the display unit 206, restricted-direction display indicating that the directions allowed to be input are restricted to the horizontal direction and the vertical direction (the four directions of up, down, left, and right). For example, as illustrated in FIG. 6B, the restricted-direction display is a black cross which is a background of the joystick 622.

In S904, the control unit 201 acquires from the operation unit 205 the direction θ of the user operation of touching the reference position of the joystick 622 and moving the touch position (displacement direction of the touch position from the reference position) and the displacement amount d, and stores the direction θ and the displacement amount d in the working memory 204. When the user operation of touching the reference position of the joystick 622 and moving the touch position is not performed, S904 to S906 are omitted.

In S905, the control unit 201 acquires the direction θ and the displacement amount d from the working memory 204, and calculates the horizontal displacement amount dh and the vertical displacement amount dv with the above-described method. The control unit 201 stores the horizontal displacement amount dh and the vertical displacement amount dv in the working memory 204. The control unit 201 restricts the direction θ to 0°, 90°, 180°, or 270°, and stores the direction θ after the restriction in the working memory 204.

In the present embodiment, in the restricted mode, during a swipe operation on the joystick 622 (during the input of the direction), the operation direction is locked to further restrict the directions allowed to be input to a direction in which the input is being performed. As the operation direction locking, horizontal locking for restricting the direction allowed to be input to the horizontal direction is performed, or vertical locking for restricting the direction allowed to be input to the vertical direction is performed. In S906, the control unit 201 acquires from the working memory 204 a setting value of the direction allowed to be input (the direction allowed to be input with the joystick 622), and determines whether or not the operation direction is being locked, on the basis of the setting value. When the operation direction is locked, the process proceeds to S915, and otherwise, the process proceeds to S907.

The control unit 201 appropriately updates the setting value of a direction allowed to be input that is stored in the nonvolatile memory 203 and the working memory 204. In the present embodiment, when the operation mode is in the restricted mode and operation locking is not being performed, the setting value of the directions allowed to be input is “4 directions”. The setting value of the direction allowed to be input is “horizontal direction” in the restricted mode and during the horizontal locking, and the setting value of the direction allowed to be input is “vertical direction” in the restricted mode and during the vertical locking. The control unit 201 determines that the operation locking is not being performed when the setting value for the direction allowed to be input is “4 directions”, and determines that the operation locking is being performed when the setting value for the direction allowed to be input is “horizontal direction” or “vertical direction”. In the unrestricted mode, the setting value of the direction allowed to be input is “360° directions”.

In S907, the control unit 201 acquires from the working memory 204 the direction θ after the restriction and the horizontal displacement amount dh, and determines whether or not the direction θ after the restriction is the horizontal direction (0° or 180°) and the absolute value of the horizontal displacement amount dh is greater than a threshold value. When the direction θ after the restriction is the horizontal direction and the horizontal displacement amount dh is larger than the threshold value, the process proceeds to S908, and otherwise, the process proceeds to S911.

The threshold value in S907 may or may not be a fixed value determined in advance by the manufacturer. There may or may not be an unresponsive area centered on the reference position, as an area related to a swipe operation on the joystick 622. In a case where there is an unresponsive area, the control unit 201 does not determine that the swipe operation has been performed if the touch position has not moved to outside the unresponsive area, and determines that the swipe operation has been performed if the touch position has moved to outside the unresponsive area. In this case, the threshold value in S907 may be equal to or different from the absolute value of the horizontal displacement amount dh up to a right end or a left end of the unresponsive area. The displacement amount compared with the threshold value may be the displacement amount d instead of the horizontal displacement amount dh. A condition that the displacement amount is larger than the threshold value may not be used.

In S908, the control unit 201 measures time with a horizontal lock timer. When the horizontal lock timer is not operating, the control unit 201 activates the horizontal lock timer. When the horizontal lock timer is operating, the control unit 201 continues the time measurement by the horizontal lock timer. When a vertical lock timer is operating, the control unit 201 (resets and) stops the vertical lock timer.

In S909, the control unit 201 determines whether or not the time measured by the horizontal lock timer (a duration in a state where the direction θ after the restriction is the horizontal direction) has reached a threshold value. When the measured time has reached the threshold value, the process proceeds to S910, and otherwise, the process proceeds to S915. When the horizontal lock timer has reached the threshold value, the control unit 201 (resets and) stops the horizontal lock timer.

In S910, the control unit 201 starts the horizontal locking. During the horizontal locking, the control unit 201 performs, on the display unit 206, restricted-direction display indicating that the direction allowed to be input is restricted to the horizontal direction. For example, as illustrated in FIG. 6C, the restricted-direction display is a black horizontal line which is a background of the joystick 622.

S908 and S909 may be omitted, and a condition that the duration in a state where the direction θ after the restriction is the horizontal direction has reached the threshold value may not be used. When S908 and S909 are omitted, the horizontal locking can be immediately started after the condition in S907 is satisfied.

In S911, the control unit 201 acquires from the working memory 204 the direction θ after the restriction and the vertical displacement amount dv, and determines whether or not the direction θ after the restriction is the vertical direction (90° or 270°) and the absolute value of the vertical displacement amount dv is greater than a threshold value. When the direction θ after the restriction is the vertical direction and the vertical displacement amount dv is larger than the threshold value, the process proceeds to S912, and otherwise, the process proceeds to S915.

The threshold value in S911 may or may not be a fixed value determined in advance by the manufacturer. There may or may not be an unresponsive area centered on the reference position, as an area related to a swipe operation on the joystick 622. In a case where there is an unresponsive area, the threshold value in S911 may be equal to or different from the absolute value of the vertical displacement amount dv up to an upper end or a lower end of the unresponsive area. The displacement amount compared with the threshold value may be the displacement amount d instead of the vertical displacement amount dv. A condition that the displacement amount is larger than the threshold value may not be used.

In S912, the control unit 201 measures time with the vertical lock timer. When the vertical lock timer is not operating, the control unit 201 activates the vertical lock timer. When the vertical lock timer is operating, the control unit 201 continues the time measurement by the vertical lock timer. When the horizontal lock timer is operating, the control unit 201 (resets and) stops the horizontal lock timer.

In S913, the control unit 201 determines whether or not the time measured by the vertical lock timer (a duration in a state where the direction θ after the restriction is the vertical direction) has reached a threshold value. When the measured time has reached the threshold value, the process proceeds to S914, and otherwise, the process proceeds to S915. When the vertical lock timer has reached the threshold value, the control unit 201 (resets and) stops the vertical lock timer.

In S914, the control unit 201 starts the vertical locking. During the vertical locking, the control unit 201 performs, on the display unit 206, restricted-direction display indicating that the direction allowed to be input is restricted to the vertical direction. For example, as illustrated in FIG. 6D, the restricted-direction display is a black vertical line which is a background of the joystick 622.

S912 and S913 may be omitted, and a condition that the duration in a state where the direction θ after the restriction is the vertical direction has reached the threshold value may not be used. When S912 and S913 are omitted, the vertical locking can be immediately started after the condition in S911 is satisfied.

In S915, the control unit 201 acquires a setting value of the direction allowed to be input (the direction allowed to be input with the joystick 622) from the working memory 204, and determines whether or not the horizontal locking is being performed, on the basis of the setting value. When the horizontal locking is being performed, the process proceeds to S916, and otherwise, the process proceeds to S917.

In S916, the control unit 201 acquires the horizontal displacement amount dh from the working memory 204, calculates the pan control value by multiplying the horizontal displacement amount dh by a coefficient, and transmits the calculated pan control value to the camera to be operated. If there is an unresponsive area related to a swipe operation of the joystick 622, and the touch position has not moved to outside the unresponsive area, the control unit 201 does not transmit the pan control value.

In S917, the control unit 201 acquires a setting value of the direction allowed to be input, from the working memory 204, and determines whether or not the vertical locking is being performed, on the basis of the setting value. When the vertical locking is being performed, the process proceeds to S918, and otherwise, the process proceeds to S919.

In S918, the control unit 201 acquires the vertical displacement amount dv from the working memory 204, calculates the tilt control value by multiplying the vertical displacement amount dv by a coefficient, and transmits the calculated tilt control value to the camera to be operated. If there is an unresponsive area related to a swipe operation of the joystick 622, and the touch position has not moved to outside the unresponsive area, the control unit 201 does not transmit the pan control value.

In S919, the control unit 201 transmits either the pan control value or the tilt control value, to the camera to be operated. The control unit 201 acquires the direction θ after the restriction, the horizontal displacement amount dh, and the vertical displacement amount dv from the working memory 204. In a case where the direction θ after the restriction is the horizontal direction (0° or 180°), the control unit 201 calculates the pan control value by multiplying the horizontal displacement amount dh by a coefficient, and transmits the calculated pan control value to the camera to be operated. In a case where the direction θ after the restriction is the vertical direction (90° or 270°), the control unit 201 calculates the tilt control value by multiplying the vertical displacement amount dv by a coefficient, and transmits the calculated tilt control value to the camera to be operated. If there is an unresponsive area related to a swipe operation of the joystick 622, and the touch position has not moved to outside the unresponsive area, the control unit 201 transmits neither the pan control value nor the tilt control value.

In S920, the control unit 201 determines whether or not the touch on the display unit 206 has been released. When the touch has been released, the operation in FIGS. 9A and 9B ends, and otherwise, the process proceeds to S904. In a case where the operation direction is locked (during the horizontal locking or during the vertical locking), the control unit 201 returns the setting value of the direction allowed to be input to “4 directions”, thereby unlocking the operation direction when ending the operation in FIGS. 9A and 9B. The condition for unlocking the operation direction is not limited to release of the touch during the operation direction lock. For example, the operation direction may be unlocked when an absolute value of a displacement amount is equal to or less than a threshold value. The threshold value in this case may be the same as or different from the threshold value used in S907 or S911.

In S921, the control unit 201 performs, on the display unit 206, unrestricted-direction display indicating that a direction allowed to be input is not restricted. For example, as illustrated in FIG. 6A, the unrestricted-direction display is the black circle which is a background of the joystick 622.

In S922, similarly to S904, the control unit 201 acquires from the operation unit 205 the direction θ of the user operation of touching the reference position of the joystick 622 and moving the touch position and the displacement amount d, and stores the direction θ and the displacement amount d in the working memory 204. When the user operation of touching the reference position of the joystick 622 and moving the touch position is not performed, S922 to S924 are omitted.

In S923, similarly to S905, the control unit 201 acquires the direction θ and the displacement amount d from the working memory 204, and calculates the horizontal displacement amount dh and the vertical displacement amount dv with the above-described method. The control unit 201 stores the horizontal displacement amount dh and the vertical displacement amount dv in the working memory 204. However, in S923, unlike S905, the direction θ is not restricted.

In S924, the control unit 201 acquires the horizontal displacement amount dh and the vertical displacement amount dv from the working memory 204. Then, the control unit 201 calculates the pan control value by multiplying the horizontal displacement amount dh by a coefficient, calculates the tilt control value by multiplying the vertical displacement amount dv by a coefficient, and transmits the calculated pan control value and tilt control value to the camera to be operated. If there is an unresponsive area related to a swipe operation of the joystick 622, and the touch position has not moved to outside the unresponsive area, the control unit 201 transmits neither the pan control value nor the tilt control value.

In S925, the control unit 201 determines whether or not the touch on the display unit 206 has been released. When the touch has been released, the operation in FIGS. 9A and 9B ends, and otherwise, the process proceeds to S922.

As described above, according to the present embodiment, a plurality of operation modes having different numbers of directions allowed to be input can be set as the operation modes of the user operation of inputting a direction by moving the operation position, such as a joystick operation. As a result, the number of user operations can be reduced as compared with a case where there is solely one operation mode in which the number of directions allowed to be input is limited. In the operation mode in which the number of directions allowed to be input is limited, during direction input, the directions allowed to be input are further restricted to the direction in which the input is being performed. As a result, likelihood of erroneous control (control unintended by the user) according to the user operation can be further reduced, and the number of user operations can be further reduced. Because the display with which a direction allowed to be input is able to be identified is performed, the user can grasp the direction allowed to be input and suitably perform the user operation.

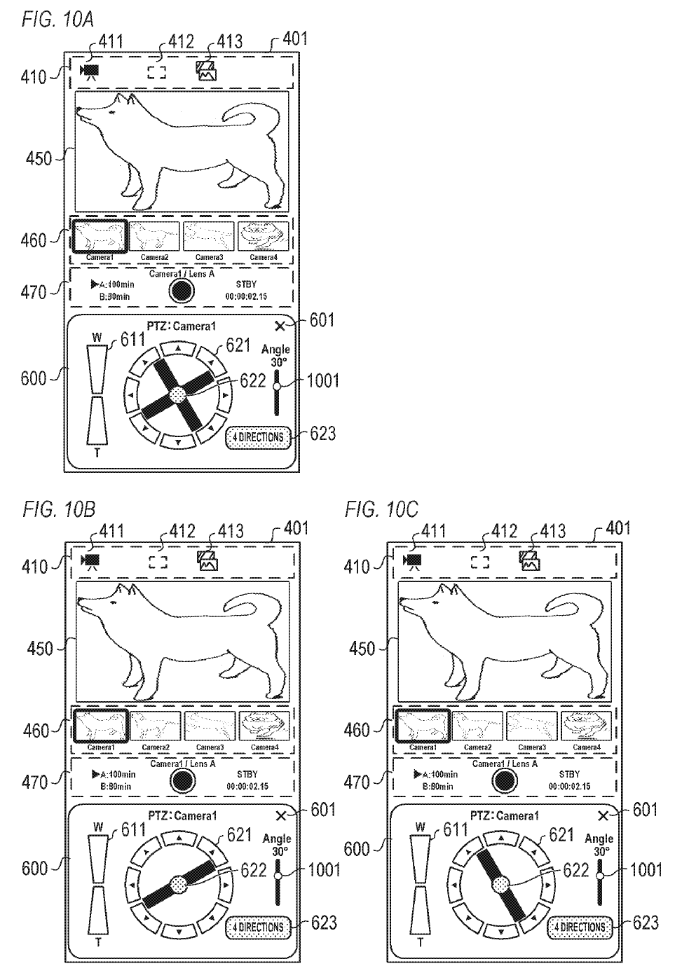

The control unit 201 may adjust the direction allowed to be input in the restricted mode according to the user operation. For example, as illustrated in FIG. 10A, the control unit 201 may display a direction setting slider 1001. The user uses the direction setting slider 1001 to specify an adjustment amount (angle) of the direction allowed to be input in the restricted mode, within a range of 0° or more and less than 90°. The control unit 201 determines (sets) an angle obtained by tilting the horizontal direction and the vertical direction by the specified adjustment amount as the direction allowed to be input in the restricted mode. Therefore, in FIG. 10A, the display in which the black cross in FIG. 6B is tilted by the specified adjustment amount is performed as the restricted-direction display. During the horizontal locking, as illustrated in FIG. 10B, the display in which the black horizontal line in FIG. 6C is tilted by the specified adjustment amount is performed as the restricted-direction display. During the vertical locking, as illustrated in FIG. 10C, the display in which the black vertical line in FIG. 6D is tilted by the specified adjustment amount is performed as the restricted-direction display. When such display is performed, in S916 and S918, the pan control value and the tilt control value may be transmitted to the camera to be operated, so that the imaging direction is controlled in a direction after the adjustment according to the specified adjustment amount and the displacement amount d.

The restricted-direction display and the unrestricted-direction display described above are examples, and the restricted-direction display and the unrestricted-direction display are not particularly limited as long as the direction allowed to be input is able to be identified.

In the restricted mode, when the displacement direction of the touch position from the reference position is within a predetermined range centered on the direction allowed to be input, the displacement direction is regarded as the direction allowed to be input. In a case where, within the predetermined range described above, a difference between the displacement direction and the direction allowed to be input is greater than a threshold value, the control unit 201 may provide a predetermined notification to the user. A 0° direction, which is a direction allowed to be input in the restricted mode, is considered. For example, when the displacement direction is within a range of 90° centered on the 0° direction, the displacement direction is regarded as the 0° direction. In a case where the displacement direction is within the range of 90° centered on the 0° direction and outside a range of a 60° centered on the 0° direction, the control unit 201 may provide the predetermined notification to the user. This also applies to a 90° direction, a 180° direction, and a 270° direction, which are directions allowed to be input in the restricted mode. The predetermined notification is achieved by, for example, vibration, sound output, display, or the like. The vibration, sound output, or display may be performed by the smartphone 200 or may be performed by another electronic device (for example, a wearable device worn by the user).

By the predetermined notification described above, the user can be notified that the touch position gradually moves upward or downward during a horizontal swipe operation on the joystick 622. The user can be notified that the touch position gradually moves rightward or leftward during a vertical swipe operation on the joystick 622. As a result, when the operation direction is not locked, it is possible to reduce likelihood of a direction of a detected swipe operation switching between the horizontal direction and the vertical direction against intention of the user. When the operation direction is locked, the user can be notified that the direction of the swipe operation cannot be switched between the horizontal direction and the vertical direction because the operation direction is locked. In the restricted mode, the predetermined notification may be performed regardless of whether or not the operation direction is locked, may be performed exclusively when the operation direction is not locked, or may be performed exclusively when the operation direction is locked.

The imaging direction may or may not be unlimitedly controllable. In a case where there is a controllable range in the imaging direction, the imaging direction cannot be controlled in a direction toward outside of the controllable range in the imaging direction. Therefore, the direction toward the outside of the controllable range in the imaging direction may not be able to be input. The control unit 201 may perform the display with which the direction allowed to be input, excluding the direction toward the outside of the controllable range in the imaging direction, is able to be identified, as the restricted-direction display or the unrestricted-direction display.

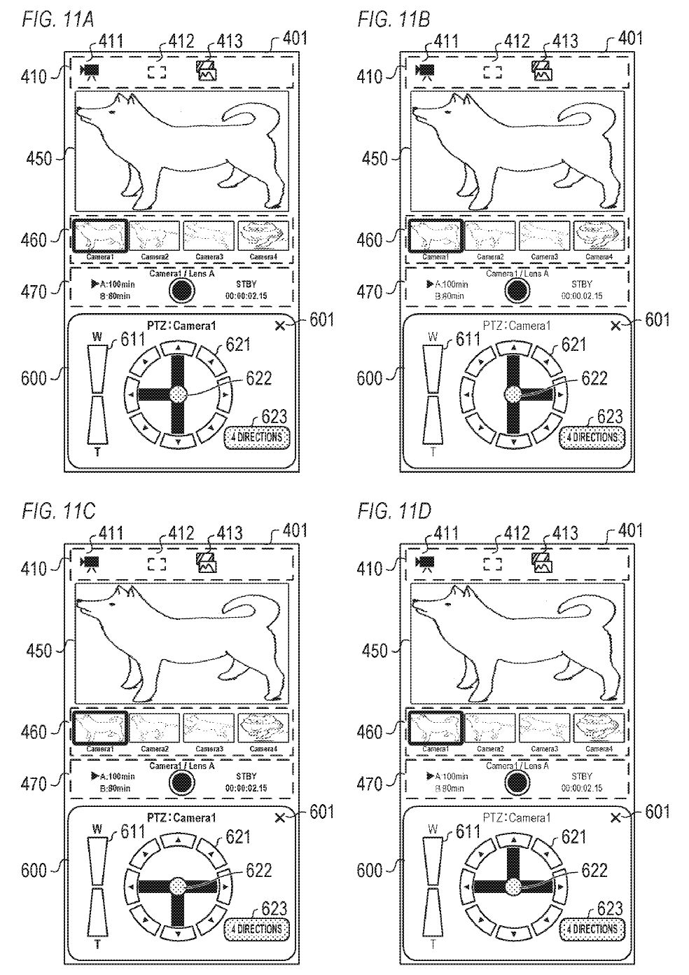

For example, in a case where the imaging direction is a direction of a right end of the controllable range and the imaging direction cannot be controlled rightward, the control unit 201 may perform the restricted-direction display in FIG. 11A indicating that three directions of up, down, and left are allowed to be input in the restricted mode. In a case where the imaging direction is a direction of a left end of the controllable range and the imaging direction cannot be controlled leftward, the control unit 201 may perform the restricted-direction display in FIG. 11B indicating that three directions of up, down, and right are allowed to be input in the restricted mode. In a case where the imaging direction is a direction of an upper end of the controllable range and the imaging direction cannot be controlled upward, the control unit 201 may perform the restricted-direction display in FIG. 11C indicating that three directions of down, left, and right are allowed to be input in the restricted mode. In a case where the imaging direction is a direction of a lower end of the controllable range and the imaging direction cannot be controlled downward, the control unit 201 may perform the restricted-direction display in FIG. 11D indicating that three directions of up, left, and right are allowed to be input in the restricted mode.

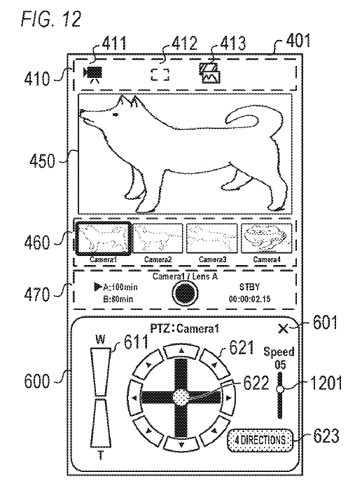

A speed of change in the imaging direction (movement of the imaging unit 202) may be specified by the user. For example, as illustrated in FIG. 12, the control unit 201 may display a speed setting slider 1201. The user uses the speed setting slider 1201 to specify a speed of change in the imaging direction (for example, the coefficient described above) with respect to the predetermined displacement amount of the touch position. The control unit 201 sets a final speed on the basis of the set speed and displacement amount d, and performs the panning motion and the tilting motion at the set speed. As described above, the larger the absolute value of the horizontal displacement amount dh, the faster the speed of the panning motion, and the larger the absolute value of the vertical displacement amount dv, the faster the speed of the tilting motion. The control unit 201 may perform the panning motion or the tilting motion at a specified speed regardless of the displacement amount d.

In this case, the control unit 201 may determine a threshold value to be used in S907, S909, S911, S913, or the like such that the operation direction lock is more likely to occur as the set speed is higher (as the speed specified by the user is higher). For example, the control unit 201 may decrease the threshold value used in S907, S909, S911, S913, or the like as the specified speed is higher. The control unit 201 may decrease a threshold value for determining whether or not to perform the predetermined notification such that the above-described predetermined notification is more likely to occur as the set speed is higher (as the speed specified by the user is higher).

The predetermined condition for the operation direction lock is not limited to the conditions in S907, S909, S911, S913 and the like. For example, the predetermined condition may include a condition that the speed of change in the imaging direction (speed of movement of the imaging unit 202, set speed) is higher than a threshold value.

Although an example in which the control unit 201 controls the imaging direction of an imaging device on the basis of a direction that is input (control of movement of an imaging unit) has been described, the control unit 201 may perform other predetermined movement control on the basis of the direction that is input. For example, on the basis of the direction that is input, the control unit 201 may move, in an image, an area to be displayed. The image is a map image, an image to be edited, or the like. The control unit 201 may move the cursor on the basis of the direction that is input. The control unit 201 may move a line of sight of the user in a game on the basis of the direction that is input. As described above, the present disclosure can be applied to various movement controls.

Note that the above-described various types of control may be processing that is carried out by one piece of hardware (e.g., processor or circuit), or otherwise. Processing may be shared among a plurality of pieces of hardware (e.g., a plurality of processors, a plurality of circuits, or a combination of one or more processors and one or more circuits), thereby carrying out the control of the entire device.

Also, the above processor is a processor in the broad sense, and includes general-purpose processors and dedicated processors. Examples of general-purpose processors include a central processing unit (CPU), a micro processing unit (MPU), a digital signal processor (DSP), and so forth. Examples of dedicated processors include a graphics processing unit (GPU), an application-specific integrated circuit (ASIC), a programmable logic device (PLD), and so forth. Examples of PLDs include a field-programmable gate array (FPGA), a complex programmable logic device (CPLD), and so forth.

The embodiment described above (including variation examples) is merely an example. Any configurations obtained by suitably modifying or changing some configurations of the embodiment within the scope of the subject matter of the present disclosure are also included in the present disclosure. The present disclosure also includes other configurations obtained by suitably combining various features of the embodiment.

According to the present disclosure, likelihood of erroneous control according to a user operation of inputting a direction by moving an operation position, such as a joystick operation, (control unintended by the user) can be reduced, and the number of user operations can be reduced.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)^{TM}), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-053249, filed March 27, 2025, which is hereby incorporated by reference herein in its entirety.

What is claimed is:

1. An electronic device comprising:
a processor; and
a memory storing a program which, when executed by the processor, causes the electronic device to
execute a setting process of setting any one of a plurality of operation modes including a first operation mode and a second operation mode in which a number of directions allowed to be input is smaller than a number of directions allowed to be input in the first operation mode, as an operation mode of an operation member, the operation member being configured to receive an input direction based on movement of an operation position of a user operation;
execute a restriction process of restricting, in the second operation mode, during direction input, a direction allowed to be input to a direction in which input is being performed; and
execute a control process of performing control so that display with which a direction allowed to be input is able to be identified is performed.

2. The electronic device according to claim 1, wherein the operation position is a touch position, and wherein the user operation is a user operation of touching and moving the touch position.

3. The electronic device according to claim 1,
wherein in the control process, control is performed so that the operation member is displayed, and
the operation position is a touch position and the user operation is a user operation of touching a predetermined position of the operation member and moving the touch position.

4. The electronic device according to claim 1, wherein in the control process, an imaging direction of an imaging device is controlled on a basis of a direction that is input.

5. The electronic device according to claim 4,
wherein a direction toward outside of a controllable range in the imaging direction is not able to be input, and
in the control process, control is performed so that display with which a direction allowed to be input, excluding the direction toward outside of the controllable range in the imaging direction, is able to be identified is performed.

6. The electronic device according to claim 1, wherein directions allowed to be input in the second operation mode are a horizontal direction and a vertical direction.

7. The electronic device according to claim 1, wherein when the program is executed by the processor, the program further causes the electronic device to execute an adjustment process of adjusting, according to a second user operation, a direction allowed to be input in the second operation mode.

8. The electronic device according to claim 1, wherein, in the second operation mode, in the restriction process, a direction allowed to be input is restricted in a case where a predetermined condition including a condition that a duration of input in a same direction has reached a threshold value is satisfied.

9. The electronic device according to claim 1,
wherein the user operation is a user operation of moving the operation position and inputting a direction and an amount of displacement of the operation position from before movement, and
in the second operation mode, in the restriction process, a direction allowed to be input is restricted in a case where a predetermined condition including a condition that a direction is input by a displacement amount larger than a threshold value is satisfied.

10. The electronic device according to claim 1,
wherein in the control process, predetermined movement control is performed on a basis of a direction that is input,
when the program is executed by the processor, the program further causes the electronic device to execute a speed setting process of setting a speed of movement by the predetermined movement control, and
in the control process, a direction allowed to be input is restricted in a case where a predetermined condition including a condition that a speed set by the speed setting process is higher than a threshold value is satisfied.

11. The electronic device according to claim 8,
wherein in the control process, predetermined movement control is performed on a basis of a direction that is input,
when the program is executed by the processor, the program further causes the electronic device to execute a speed setting process of setting a speed of movement by the predetermined movement control, and
in the control process, the threshold value is determined on a basis of a speed set by the speed setting process.

12. The electronic device according to claim 11, wherein in the control process, the threshold value is determined such that restriction by the restriction process is more likely to occur as a speed set by the speed setting process is higher.

13. The electronic device according to claim 1,
wherein, in the second operation mode,
in a case where a displacement direction of the operation position from before movement is within a predetermined range centered on a direction allowed to be input, the displacement direction is regarded as a direction allowed to be input, and
in a case where, within the predetermined range, a difference between the displacement direction and the direction allowed to be input is greater than a threshold value, in the control process, control is performed to provide a predetermined notification.

14. The electronic device according to claim 13, wherein in the control process, control is performed to provide the predetermined notification with vibration.

15. A control method of an electronic device, comprising:
setting any one of a plurality of operation modes including a first operation mode and a second operation mode in which a number of directions allowed to be input is smaller than a number of directions allowed to be input in the first operation mode, as an operation mode of an operation member, the operation member being configured to receive an input direction based on movement of an operation position of a user operation;
restricting, in the second operation mode, during direction input, a direction allowed to be input to a direction in which input is being performed; and
performing control so that display with which a direction allowed to be input is able to be identified is performed.

16. A non-transitory computer readable medium that stores a program, wherein the program causes a computer to execute a control method of an electronic device, the control method comprising:
setting any one of a plurality of operation modes including a first operation mode and a second operation mode in which a number of directions allowed to be input is smaller than a number of directions allowed to be input in the first operation mode, as an operation mode of an operation member, the operation member being configured to receive an input direction based on movement of an operation position of a user operation;
restricting, in the second operation mode, during direction input, a direction allowed to be input to a direction in which input is being performed; and
performing control so that display with which a direction allowed to be input is able to be identified is performed.
